(19) United States
(12) Patent Application Publication
(10) Pub. No.: US 2011/0061933 A1
(43) Pub. Date: Mar. 17, 2011

(54) FLAT CABLE FOR USE WITH AN ELECTRONIC DEVICE

(75) Inventor: Christopher Prest, San Francisco, CA (US)

(73) Assignee: Apple Inc., Cupertino, CA (US)

(21) Appl. No.: 12/722,303

(22) Filed: Mar. 11, 2010

Related U.S. Application Data
(60) Provisional application No. 61/241,691, filed on Sep. 11, 2009.

(51) Int. Cl. H01B 7/00; H01R 43/00; H01R 12/24

(52) U.S. Cl. 174/75 R; 29/825; 439/498

(57) ABSTRACT

This is directed to a cable for use with an electric device in which the conductive medium used to conduct electrical signals is a flex instead of distinct wires. The flex can include any suitable number of conductive traces connecting connectors integrated in or coupled to the ends of the flex. Using a flex can allow a user to roll the cable more easily, and reduce tangling of the cable. In addition, the flex may be more resistant to bending in particular desired directions.

### BACKGROUND OF THE INVENTION

This is directed to a flat cable for use with an electronic device. In particular, this is directed to a USB cable supported by a flexible circuit.

Cables used to connect electronic devices to other components can include a conductive medium between connectors. The conductive medium typically includes one or more wires (e.g., four wires) placed within a non-conductive enclosure for protecting the wires from undesired electrical events and from damage. In some cases, the cable can be constructed by molding a sheath around wires, or by extruding a sheath that into which the wires can be threaded. The resulting cable can have a circular or elliptical cross-section, which can allow the cable to bend equally well or near-equally well in all directions. In some cases, however, the connector coupled to the wires can have a specific orientation and be more susceptible to damage or failure when the cable bends in a particular direction or orientation relative to the connector (e.g., when a cable bends away from a first connector contact and towards an opposite connector contact). In addition, the manufacturing approach used to connect individual wires to the connector (e.g., soldering) can be susceptible to bending or other cable movement in particular orientations.

### SUMMARY OF THE INVENTION

This is directed to a flat cable for connecting electronic devices. In particular, this is directed to a cable in which a flex circuit is used to couple connectors forming the cable.

Many electronic cables are constructed from several distinct wires connected to connectors and surrounded by a non-conductive sheath. The resulting cable can have a circular or elliptical cross-section, which allows the cable to bend in any direction. This may not be desirable, however, as bending in some directions can stress the coupling between the wires and the connectors.

Instead of using wires, a cable can be constructed using a flex as the conductive material between the connectors. Such a flattened or ribbon-like cable can be less prone to tangle, can roll more easily for storage, and can provide controlled bending in two directions (e.g., as opposed to unhindered bending in all directions). The flex can be coupled to connectors using any suitable approach. In some embodiments, a connector can be coupled to the flex by soldering, SMT, or any other suitable process. Alternatively, the connector can be embedded within the flex traces (e.g., expose particular traces in a particular pattern to form a connector).

In some embodiments, an electrical circuit can be embedded within the flex as part of the cable. For example, the cable can include an integrated circuit for electrostatic discharge (ESD), an LED, power detection, or any other suitable purpose. In one implementation, the cable can include an embedded circuit for multiplexing signals.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a cross-sectional view of a cable using wires as a conductive portion in accordance with one embodiment of the invention;

FIG. 2 is a schematic view of an illustrative flex-based cable in accordance with one embodiment of the invention;

FIG. 3 is a cross-sectional view of a portion of the cable of FIG. 2 in accordance with one embodiment of the invention;

FIG. 4 is a top view of the cable of FIG. 2 in accordance with one embodiment of the invention;

FIGS. 5A and 5B are perspective views of the connector of the cable of FIG. 2 in accordance with one embodiment of the invention;

FIG. 6 is a schematic view of the flex of the cable of FIG. 2 being placed in a carrier in accordance with one embodiment of the invention;

FIG. 7 is a schematic view of an illustrative cable having incorporated circuitry in accordance with one embodiment of the invention; and

FIG. 8 is a flowchart of an illustrative process for creating a cable using a flex in accordance with one embodiment of the invention.

### DETAILED DESCRIPTION

Different electronic devices can be connected to each other to transfer power, data, or combinations of these using one or more cables having connectors that can be coupled to the different devices. For example, a cable can include connectors of the same type (e.g., USB connectors) or of different types (e.g., a USB connector and a 30-pin connector). The cables can have any suitable number of channels, including for example a number set by the type of connector used for the wire. Each channel can be constructed using different approaches, including for example from individual wires enclosed by a sheath. The individual wires can be connected to connectors using any suitable approach, including for example soldering, SMT, or combinations of these. In some cases, however, the connector can bend relative to the wires at angles that cause high stresses to build up, and can increase the chance or rate of failure of the wire-connector junction.

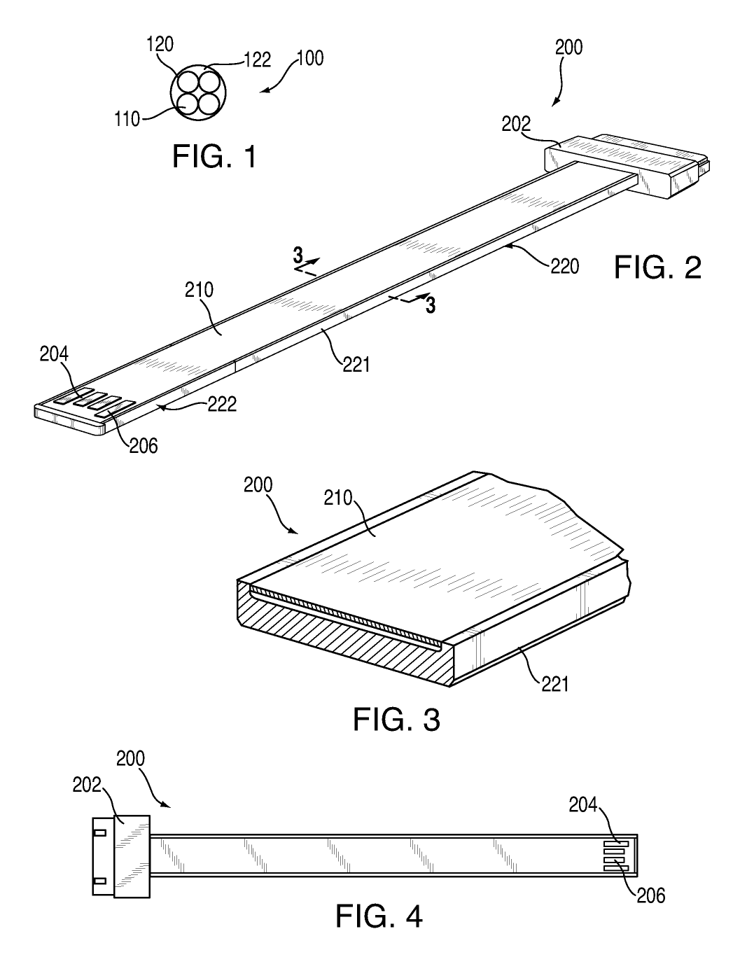

FIG. 1 is a cross-sectional view of a cable using wires as a conductive portion in accordance with one embodiment of the invention. Cable 100 can include individual conductive wires 110 each serving as a channel to conduct different signals across the cable. In particular, each wire 110 can provide a signal between different connectors integrated or connected at each end of cable 100. To avoid shorting or interference between adjacent wires, each wire 110 can be surrounded by a non-conductive sheath. Alternatively, wires 110 can be enclosed within sheath 120 such that non-conductive material 122 electrically isolates each wire 110. Sheath 120 can also be used to maintain the distribution of the wires in cable 100. Sheath 120 can have any suitable cross-section, including for example a circular or elliptical cross section.

Each end of cable 100 can include a connector operative to engage an electronic device. Each connector can include several conductive pins assigned to conduct particular signals (e.g., data channels, power, or ground signals), each of which can be connected to a corresponding wire, such that pins of opposite connectors assigned to the same signal are connected via a wire. Cable 100 can include any suitable type of connector, including for example a USB connector, 30-pin connector, display connector, power connector, or combination of these. Because the wires of the cable are provided in a circular or elliptical configuration, the cable can bend equally in all directions or orientations. If an interface between a connector and a wire is less resistant to bending or twisting along a particular orientation, the cable may be susceptible to failure.

To reduce stress points on the cable-connector interface, the channels of the cable can be constructed to favor bending of the cable in one or more particular orientations. For example, the cable can be constructed such that the channels have a non-circular cross-section (e.g., a flatter profile). In one implementation, the conductive element of the cable can include conductive traces printed on a flex. FIG. 2 is a schematic view of an illustrative flex-based cable in accordance with one embodiment of the invention. FIG. 3 is a cross-sectional view of a portion of the cable of FIG. 2 in accordance with one embodiment of the invention. FIG. 4 is a top view of the cable of FIG. 2 in accordance with one embodiment of the invention. Cable 200 can include connectors 202 and 204 at opposite ends of flex 210. For example, cable 200 can include 30-pin connector 202 and USB connector 204, or any other suitable type of connector (e.g., a FireWire connector). Flex 210 can include any suitable number of conductive traces between connectors 202 and 204, including for example four distinct traces. In other cases, the size of the flex (e.g., the width of the flex) or the number of conductive channels or paths required for each connector can determine the number of conductive traces included in flex 210, as well as the size of flex 210. The length of flex 210 can be selected based on any suitable criteria, including for example the required signal strength for transferring signals between the connectors, industrial design considerations, user interaction considerations, or any other suitable criteria. In one implementation, the length of flex 210 can be in the range of 50 cm to 200 cm, such as 150 cm.

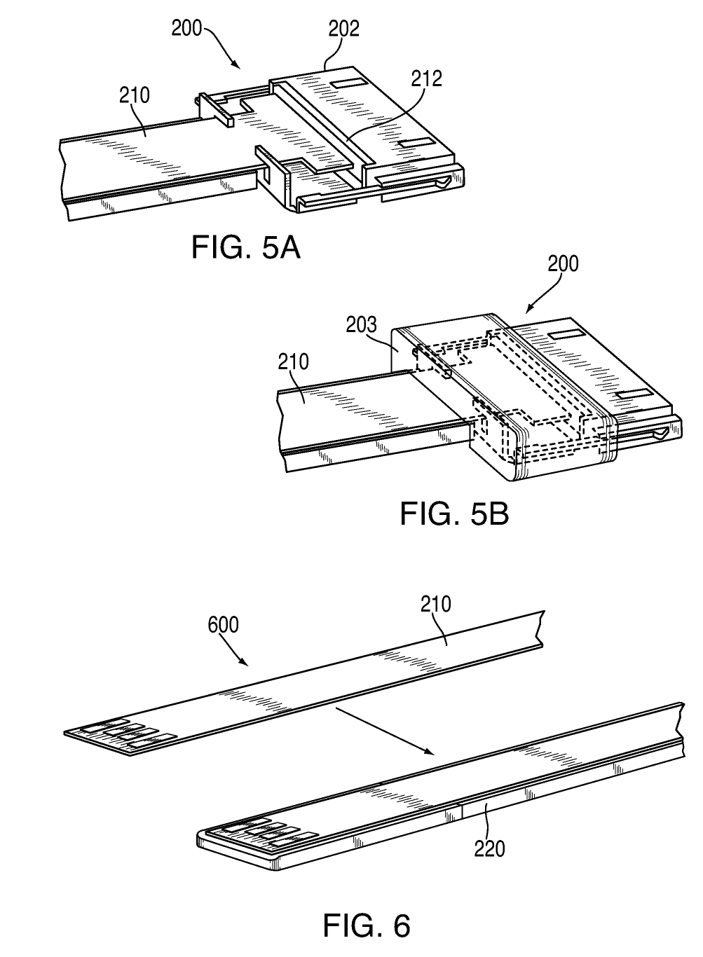

Flex 210 can be coupled to each of connectors 202 and 204 using any suitable approach. In one embodiment, flex 210 can be connected to a connector (e.g., connector 202) using soldering, SMT, or a combination of these and other processes for making an electrical connection. FIGS. 5A and 5B are perspective views of the connector of the cable of FIG. 2 in accordance with one embodiment of the invention. As shown in FIG. 5A, flex 210 can be coupled to connector 202 using soldering. In particular, each exposed trace 212 of flex 210 can be connected to a corresponding contact or pin of connector 202. Once the flex is electrically connected to connector 202, protective boot 203 can be placed over the flex-connector interface to protect the coupling. In some embodiments, protective boot 203 can form part of the connector (e.g., an enclosure that is inserted in an electronic device to ensure the alignment of the connector pins with the corresponding connector housing of the electronic device).

In some embodiments, portions of flex 210 can be exposed, or alternatively conductive elements can be placed on flex 210 to form a connector. As seen from FIGS. 2 and 4, flex 210 can include several conductive elements 206 exposed on the surface of flex 210. Each conductive element can have a particular size and position on the flex, for example set by a standard defining the connector attributes. In the example of cable 200, conductive elements 206 can include four distinct contact pads positioned and sized in accordance with the USB connector specification. Conductive elements 206 can be constructed from any suitable material and using any suitable process, including for example from copper connected to traces located within flex 210.

To protect and support flex 210, cable 200 can include carrier 220. FIG. 6 is a schematic view of the flex of the cable of FIG. 2 being placed in a carrier in accordance with one embodiment of the invention. Carrier 220 can be constructed from any suitable material, including for example plastic, metal, a composite material, silicon, or any other suitable material. In some cases, carrier 220 can form a housing into which flex 210 can be placed and retained, for example using an adhesive, press fit, engaging member, molding (e.g., double shot process when several distinct sections of the carrier), or any other suitable approach. In the example of FIG. 6, carrier 220 is shown covering only one planar surface of flex 210, and part of the side walls of flex 210 (e.g., extending near or up to the height of the flex, but not higher than the flex). In some cases, carrier 220 can instead or in addition cover the entirety of flex 210 (e.g., serving as a sheath, similar to cables constructed using wires).

In some embodiments, carrier 220 can include distinct portions having different mechanical or physical characteristics. For example, carrier 220 can include flexible portion 221 that allows cable 200 to be bent or rolled for storage, and rigid portion 222 that does not deflect to be inserted into an electronic device as part of a connector. In some cases, flexible portion 221 can have different levels of flexibility such that different regions of cable 200 can bend in different manners. For example, carrier 220 may allow the cable to bend in any manner between the connectors, but may become partially rigid and restrict the bending orientations of the cable adjacent to the connectors (e.g., only allow bending out of the flex plane near the connectors).

In some embodiments, flex 210 can be surrounded or enclosed by a sheath for aesthetic purposes. Alternatively, carrier 220 and the top surface of flex 220 can be finished to provide an aesthetically pleasing cable. In some cases, flex 210 can instead or in addition include a cosmetic coating such that the flex remains visible as a cosmetic element of the cable.

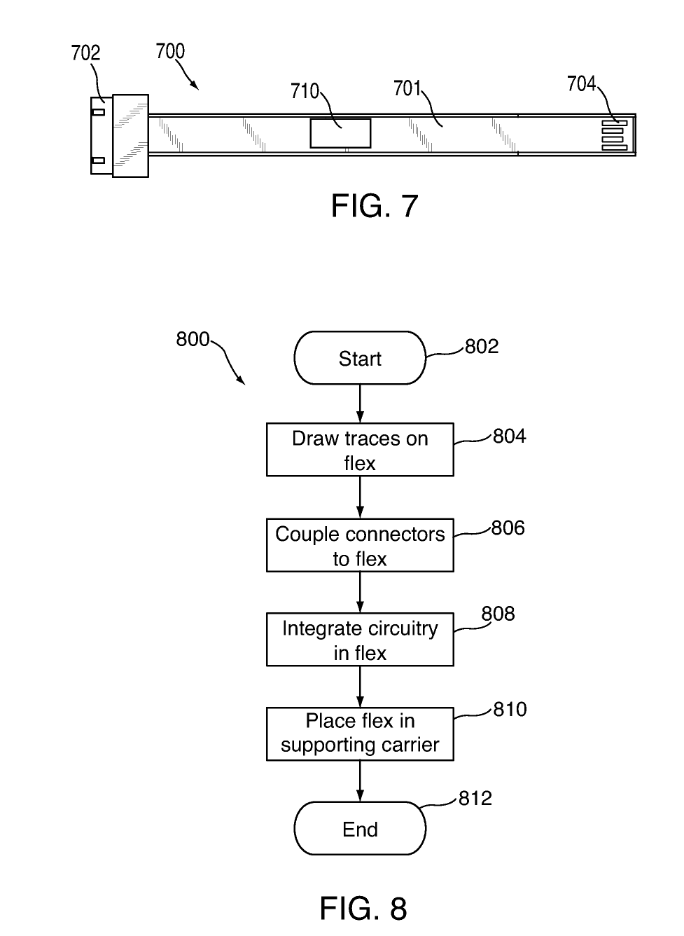

In some embodiments, the functionality of the cable can be increased or enhanced by taking advantage of the flex used as the conductive channel between the cable connectors. In particular, the flex can include intermediate or additional traces between the connectors for supporting circuitry embedded within the connector. FIG. 7 is a schematic view of an illustrative cable having incorporated circuitry in accordance with one embodiment of the invention. Cable 700 can include flex 701 providing channels for signals between connectors 702 and 704. Flex 701 can have any suitable number of traces along different paths, including for example traces connecting contact pins or regions of connectors 702 and 704. In some cases, flex 701 can instead or in addition include one or more intermediate traces that do not extend between the connectors. Instead, the one or more intermediate traces may be coupled to circuitry 710 embedded within the flex. Circuitry 710 can perform any suitable operation for cable 700, including for example detect and control power use (e.g., block power surges or shorts), encrypt or decrypt transmitted signals, multiplex received signals for a single channel (e.g., when providing signals between a connector having few pins and a connector having a larger number of pins), repeat received signals for transmission over larger distances, provide an indication of signal transfers to a user (e.g., via a LED), indicate whether a cable can be safely disconnected (e.g., using one or more LEDs), or combinations of these.

To prevent damage to circuitry 710 due to bending cable 700, a more rigid cover or carrier can be placed over flex 701 in the region adjacent to circuitry 710. For example, a carrier having variable stiffness can be placed around flex 701 such that the portion of flex supporting circuitry 710 remains substantially immobile. In some embodiments, flex 701 can itself include one or more additional layers of structural material, traces, vias or other elements (e.g., in the flex stack) to provide electrical or mechanical functionality. For example, flex 701 can include an additional layer of structural material to ensure consistent electrical connections between the circuitry and the flex, as well as additional traces for connecting the circuitry to the flex. As another example, flex 701 can include several layers of conductive and non-conductive material to provide integrated electromagnetic shielding (e.g., the additional traces of the flex shield circuitry 710).

FIG. 8 is a flowchart of an illustrative process for creating a cable using a flex in accordance with one embodiment of the invention. Process 800 can begin at step 802. At step 804, traces can be drawn on a flex. For example, traces connecting opposite ends of the flex can be drawn. As another example, traces within the flex for supporting embedded circuitry can be drawn. The traces can be provided using any suitable conductive material, including for example copper. At step 806, connectors can be coupled to the flex. For example, individual pins of connectors can be coupled to individual traces of the flex. The connectors can be the same or different, and connected to particular traces such that data, power or both can be transmitted across the flex between the connectors. At step 808, circuitry can be integrated in the flex. For example, circuitry (e.g., a chip) can be placed on the flex such that traces drawn on the flex connect appropriate pins of the circuitry. The circuitry can provide any suitable functionality, including for example detecting and controlling power use, repeating, encrypting, decrypting, or multiplexing transmitted signals, providing an indication of signal transfers, or combinations of these. At step 810, the flex can be placed in a carrier. The carrier can be selected based on mechanical, electrical, or cosmetic considerations. For example, a carrier can be selected to allow bending of the flex cable in particular regions and along particular orientations, while providing an aesthetically pleasing cable. Process 800 can then end at step 812.

The previously described embodiments are presented for purposes of illustration and not of limitation. It is understood that one or more features of an embodiment can be combined with one or more features of another embodiment to provide systems and/or methods without deviating from the spirit and scope of the invention.

What is claimed is:

1. A cable for connecting two electronic devices, comprising:
a first connector operative to engage a first electronic device;
a second connector operative to engage a second electronic device; and
a flex comprising a plurality of conductive traces, wherein the flex is coupled to the first connector at a first end and to the second connector at a second end.

2. The cable of claim 1, wherein:
the first connector comprises a plurality of conductive pins; and
each of the plurality of conductive pins of the first connector is electrically connected to at least one conductive trace of the flex.

3. The cable of claim 2, wherein:
the second connector comprises a plurality of conductive pins; and
each of the plurality of conductive pins of the second connector is electrically connected to at least one conductive trace of the flex.

4. The cable of claim 3, wherein:
at least one of the plurality of conductive pins of the first connector corresponds to at least one of the plurality of conductive pins of the second connector; and
at least one conductive trace of the flex electrically connects the at least one of the plurality of conductive pins of the first connector to the corresponding at least one of the plurality of pins of the second connector.

5. The cable of claim 1, further comprising:
a carrier operative to receive the flex, wherein the carrier covers at least one surface of the flex to protect it from damage.

6. The cable of claim 5, wherein the carrier comprises different sections having different mechanical properties.

7. The cable of claim 6, wherein the carrier comprises different sections having different stiffness.

8. The cable of claim 7, wherein the carrier is stiffer in regions adjacent to the first and second connectors, and less stiff in regions away from the first and second connectors.

9. The cable of claim 1, wherein:
the first and second connectors comprise at least one of a 30-pin connectors, a USB connector, and a FireWire connector.

10. A method for manufacturing a cable connecting electronic devices, comprising:
cutting a flex to form a strip;
drawing at least one conductive trace on the flex, wherein the at least one conductive trace extends between opposite first and second ends of the strip;
connecting a first connector to the at least one conductive trace at the first end of the strip, wherein the first connector is operative to be coupled to an electronic device; and
connecting a second connector to the at least one conductive trace at the second end of the trip, wherein the second connector is operative to be coupled to an electronic device.

11. The method of claim 10, wherein connecting the first connector further comprises:
retrieving an assembled connector; and
securing at least one conductive pin of the first connector to the at least one conductive trace.

12. The method of claim 10, wherein connecting the first connector further comprises:
incorporating a contact pad on the flex, wherein the contact pad is electrically connected to the at least one conductive trace.

13. The method of claim 10, further comprising:
defining a carrier having a bottom surface and side walls, wherein the side walls extend from the bottom surface; and
inserting the flex strip within the carrier such that the flex strip is retained against the bottom surface between the side walls of the strip.

14. The method of claim 1, wherein:
the side walls do not extend beyond the height of the flex strip.

15. The method of claim 10, further comprising:
incorporating circuitry on the flex between the first and second connectors.

16. A cable for connecting electronic devices, comprising:
a first connector operative to be coupled to an electronic device;
a second connector operative to be coupled to an electronic device;
a flex circuit comprising a plurality of traces, the plurality of traces connecting the first connector the second connector; and
circuitry coupled to the flex, wherein the circuitry is operative to affect signals transmitted across the flex between the first and second connectors.

17. The cable of claim 16, further comprising:
a carrier operative to receive the flex, wherein the carrier covers at least one surface of the flex such that the carrier has variable stiffness.

18. The cable of claim 17, wherein:
the stiffness of the carrier is higher in the vicinity of the circuitry and lower away from the vicinity of the circuitry.

19. The cable of claim 16, wherein the circuitry comprises at least one of:
detect power use;
limit power transfers;
encrypt transmitted signals;
decrypt transmitted signals;
multiplex transmitted signals between the first and second connectors;
repeat transmitted signals;
indicate the presence of signals transferred; and
indicate whether a cable can be safely disconnected.

20. The cable of claim 16, wherein the first and second connectors comprise at least one of:
a USB connector;
a 30-pin connector;
a FireWire connector; and
a power connector.
